(19) United States
(12) Patent Application Publication
(10) Pub. No.: US 2019/0054917 A1
(43) Pub. Date: Feb. 21, 2019

(54) Method and Device for Controlling a Drive Unit

(71) Applicant: Robert Bosch GmbH, Stuttgart (DE)

(72) Inventors: Nicolas Sommer, Remseck (DE); Ronald Canisius, Kornwestheim (DE); Juergen Pantring, Schwieberdingen (DE); Jens Werneth, Stuttgart (DE); Andreas Heyl, Sunnyvale, CA (US)

(21) Appl. No.: 15/767,266

(22) PCT Filed: Sep. 9, 2016
(86) PCT No.: PCT/EP2016/071305

§ 371 Date: Apr. 10, 2018

(30) Foreign Application Priority Data
Nov. 22, 2015 (DE) 10 2015 220 600.9

(51) Int. Cl. B60W 30/09; B60W 10/02; B60W 10/04; B60W 10/18; B60W 50/14; B60W 50/04

(52) U.S. Cl. CPC B60W 30/09; B60W 10/02; B60W 10/04; B60W 2550/20; B60W 50/14; B60W 50/045; B60W 2550/10; B60W 10/18

(57) ABSTRACT

A method for actuating a drive assembly in a vehicle includes evaluating a signal of a surroundings-detection apparatus. The vehicle includes the surroundings-detection apparatus, which is configured to observe the surroundings of the vehicle. The method further includes executing a first monitoring function or executing a second monitoring function as a function of the evaluation of the signal of the surroundings-detection apparatus. The first and second monitoring functions are configured to avoid undesired movements of the vehicle.

The invention relates to a method and to a device for actuating a drive assembly. In addition, the invention relates to a computer program, to a machine-readable storage medium, to a drive train of a vehicle and to a vehicle.

### PRIOR ART

Vehicles with controllable drive assemblies are known. The drive assemblies are actuated as a function of a driver's request so that as a result the vehicle moves as intended. Depending on the type of drive assembly, that is to say internal combustion engine or electrical or hydraulic drive, different safety concepts are known which avoid undesired acceleration or movement of the vehicle. A method for what is referred to as torque monitoring is known from DE 198 51 457. In the described method, a setpoint value is compared with an actual value of the current torque and the setpoint value is corrected as a function of the difference. During the further development of such safety concepts for further drive assemblies, their specific properties have to be taken into account. Therefore, for example electric machines or hydraulic assemblies can generate their maximum torque already from a stationary state. There is a need to improve the actuation processes in such a way that these particular features are taken into account.

### DISCLOSURE OF THE INVENTION

A method for actuating a drive assembly in a vehicle is made available. The vehicle comprises here a surroundings-detection apparatus for observing the surroundings of the vehicle. The method comprises here at least a first and a second monitoring function. The method comprises the following steps: evaluating a signal of the surroundings-detection apparatus and executing the first monitoring function or the second monitoring function as a function of the evaluation of the signal of the surroundings-detection apparatus.

A method for actuating a drive assembly is made available in which different monitoring functions are executed as a function of a signal of the surroundings-detection apparatus. A method for avoiding undesired movement of a drive assembly or the vehicle coupled thereto is thus advantageously made available in which, as a function of a signal of the surroundings-detection apparatus, a detected situation is reacted to differently by means of different monitoring functions, in that the drive assembly is actuated differently.

In another refinement of the invention, the evaluation of the signal of the surroundings-detection apparatus comprises the detection of whether an obstacle is located within a predefinable distance. If during this evaluation no obstacle is detected within the predefinable distance, the first monitoring function is executed. If during this evaluation an obstacle is detected within the predefinable distance, the second monitoring function is executed.

The evaluation of the signal of the surroundings-detection apparatus serves to detect whether an obstacle, in particular a living being, a person, a device which requires protection, a building, or some other object, is located within a predefinable distance. The evaluated signal of a surroundings-detection apparatus is advantageously used to decide which monitoring function is to be activated in order to avoid undesired movements. In the event of a corresponding obstacle being detected within the predefinable distance, a monitoring function is activated which is adapted to the detected obstacle.

In particular, the predefinable distance can be defined or adapted, that is to say varied, as a function of a vehicle speed, the position of the vehicle and/or of other ambient conditions. In particular, the position of the vehicle is determined as a function of the data of a navigation system or of the surroundings-detection apparatus itself.

In another refinement of the invention there is provision that the first monitoring function and the second monitoring function differ. In particular, the execution of the second monitoring function is more costly than the execution of the first monitoring function. In particular, the execution of the second monitoring function comprises at least one additional method step in comparison with the execution of the first monitoring function. In particular, the execution of the second monitoring function comprises at least one other method step which is configured, in particular, in a different way in comparison with a method step of the first monitoring function. Therefore, the second monitoring function permits precise detection or diagnosis as to whether an obstacle is located within a predefinable distance.

The monitoring functions differ in such a way that the method steps which are contained therein are of different types. The number of method steps which are to be executed within the monitoring functions also differ. For example, in particular the execution of the second monitoring function is more costly than the execution of the first monitoring function. Therefore, in the second monitoring function it is advantageously possible to take into account additional functionalities, evaluation rules (two-error principle), information to the driver, adapted parameter ranges or parameters and/or adapted deviation tolerances. The first monitoring function comprises, in particular, at least one such additional functionality or one such additional method step less than the second monitoring function. Therefore, the method for actuating a drive assembly when an obstacle is present within a predefinable distance is correspondingly adapted. Conversely, the method for actuating a drive assembly is also adapted for the case in which no obstacle is detected within the predefinable distance. The method correspondingly requires fewer resources for the sole execution of the first monitoring function, as the functionality of said function or the method steps thereof is not as extensive as those of the second monitoring function. An efficient scope with the resources, in particular computing capacity, computing time and ageing of the components used, is therefore made possible.

In another refinement of the invention, the execution of the second monitoring function comprises setting a special state of the vehicle.

In reaction to the detected obstacle within the predefinable distance, which could potentially be put in danger by undesired movement of the vehicle driven by the drive assembly, the execution of the second monitoring function comprises setting a special state of the vehicle. This special state serves to reduce the potential risk of the vehicle for the obstacle and vice versa. The risk potential which the vehicle could have for the surroundings, and vice versa, is therefore advantageously reduced.

In another refinement of the invention, the special state comprises deactivation of the drive train, opening of a transmission clutch, stopping of the creeping function and/or active braking of the vehicle.

The special state can comprise one or more method steps which serve to reduce further the probability of undesired movement of the drive assembly and therefore of the vehicle. These include, for example, deactivation of the drive train. This is to be understood as meaning, for example, that the energy supply at the drive train, for example a fuel supply, an electrical energy supply or the supply of hydraulic oil is interrupted. These measures serve to prevent the drive assembly and therefore the vehicle from being able to carry out any further undesired movements. Another special state is set by opening a transmission clutch. The opening of the transmission clutch makes a disconnection of the drive assembly from the drive wheels of the vehicle. In this state, the probability of a further undesired movement of the vehicle owing to the interrupted force flow in the drive train is also reduced. Another special state is set by the stopping of the creeping function of the vehicle. In the event of an obstacle being detected within the predefinable distance, the creeping function of the vehicle, that is to say, for example, the automatic very slow movement of a vehicle when the brake is not activated, is prevented. In this state, the probability of a further undesired movement of the vehicle is also reduced. Another special state is set by the active braking of the vehicle. This method step also reduces the probability of undesired movement owing to the drive assembly, since the activated brake counteracts the potential torque of the drive train. With the setting of a special state a corresponding message is preferably output to the driver. Furthermore, the driver is provided with the possibility of actively cancelling again the special state which has been set. The risk to the surroundings of the vehicle is therefore advantageously actively reduced. The driver is enabled to intentionally take up control of the further movement of the drive assembly and of the vehicle again by intentionally deactivating the special state.

In a further refinement of the invention, the method is carried out only within a predefinable speed range of the vehicle.

There is provision that the method for actuating a drive assembly which comprises a plurality of monitoring functions is carried out only within a predefinable speed range. Depending on the speed range, the types and the level of the risks which arise as a result of an undesired movement of the vehicle differ. It is therefore advantageous to execute a method which is adapted to the risks, within a predefinable speed range. Predefinable speed ranges here can be, in particular, the stationary state of the vehicle, driving in a zone with traffic calming, driving in town traffic, driving on a country road and/or driving on a freeway. In particular, the sensitivity of the surroundings-detection apparatus can be adapted to the predefinable speed range. Therefore, when the method is used in a speed range with relatively low speeds, for example smaller obstacles or shorter distances within which the obstacles are to be detected should also be taken into account as compared with when the method is used in speed ranges with relatively high speeds.

In another embodiment of the invention, the method is carried out only when specific traffic situations are present.

Specific traffic situations can be, in particular, situations where specific relationships between the distance of the vehicle and the obstacle or object to be taken into account are present. These specific traffic situations comprise, in particular, backed-up lines of vehicles in which vehicles travel closely one behind the other and/or one next to the other, overtaking processes in which the vehicle travels very closely against another vehicle travelling in the same direction, and/or situations in which a vehicle drives through a crowd of people. The possibility is thus advantageously made available of taking into account different traffic situations and of permitting the actuation of a drive assembly in a way which is correspondingly adapted to these traffic situations.

In another refinement of the invention, the surroundings-detection apparatus comprises a sensor, in particular a driving assistance system, in particular a radar sensor, ultrasonic sensor, laser sensor and/or a camera.

The surroundings-detection apparatus comprises a sensor for observing the surroundings of the vehicle. The sensor can be, in particular, that of a driver assistance system. A component of the vehicle which is present is therefore advantageously used and does not have to be additionally available for this method. This sensor can be embodied, for example, as a radar sensor, ultrasonic sensor, laser sensor or as a camera, in particular a video camera, or as a combination or fusion of such sensors. Different sensors which permit the surroundings of the vehicle to be observed are therefore advantageously made available.

In addition, a computer program is made available which is configured to execute the previously described method.

In addition, a machine-readable storage medium is made available on which the computer program is stored.

In addition, a device for actuating a drive assembly in a vehicle is made available. The vehicle comprises a surroundings-detection apparatus for observing the surroundings of the vehicle. The device is configured to evaluate a signal of the surroundings-detection apparatus and to execute, as a function of the evaluation of the signal of the surroundings-detection apparatus, a first monitoring function or a second monitoring function for avoiding undesired movements of the vehicle.

A device for actuating a drive assembly in a vehicle is made available. The device executes different monitoring functions as a function of a signal of the surroundings-detection apparatus. A device for avoiding undesired movement of a drive assembly or of the vehicle coupled thereto is therefore advantageously made available, which device reacts differently to a detected situation by means of different monitoring functions as a function of a signal of a surroundings-detection apparatus, in that said device actuates the drive assembly differently.

In addition, a drive train of a vehicle having a drive assembly and a device as claimed in claim 11 is made available.

A drive train is made available which comprises a drive assembly, in particular an internal combustion engine, an electric machine and/or a hybrid assembly, and a device for actuating this drive assembly. A drive train is advantageously made available which comprises a device or actuation means which minimizes undesired movements of the vehicle as a function of the surroundings.

In addition, a vehicle having a described drive train is made available. A vehicle is advantageously made available having a device or an actuation means of the drive train which minimizes undesired movements of the vehicle.

Of course, the features, properties and advantages of the method according to the invention apply, or can be applied, correspondingly to the device or to the drive train and the vehicle, and vice versa.

Further features and advantages of the embodiments of the invention are apparent from the following description with respect to the appended drawings.

### BRIEF DESCRIPTION OF THE DRAWING

The invention will be explained in more detail below with reference to a number of figures, in which

FIG. 1 shows a flowchart of a method for actuating a drive assembly.

FIG. 2 shows a vehicle having a drive train and a device for actuating a drive assembly in a schematic illustration.

### EMBODIMENT OF THE INVENTION

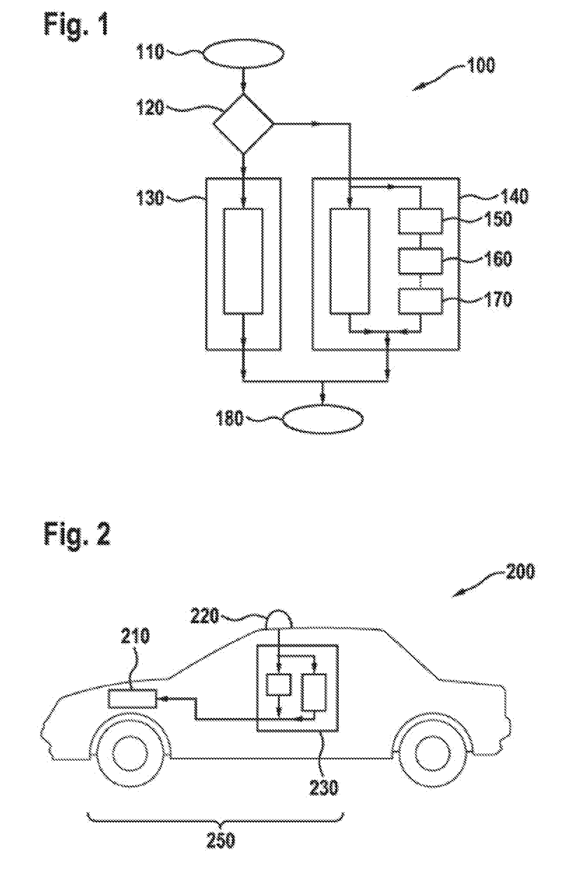

FIG. 1 shows a method 100 for actuating a drive assembly 210 in a vehicle 200. The method starts with step 110. In step 120, the signal of a surroundings-detection apparatus 220 is evaluated. The evaluation 120 of the signal of the surroundings-detection apparatus 220 comprises detecting whether an obstacle is located within a predefinable distance. An obstacle comprises here any objects which can be detected by means of a surroundings-detection apparatus and for which, in particular, contact with the vehicle is to be ruled out. The predefinable distance always corresponds to a larger distance than the distance which, owing to an unavoidable undesired movement, the vehicle would travel before the vehicle can be stopped by the overall system. This distance can be of different lengths depending on the operating situation or property, for example the weight, of the vehicle. In the stationary state, this is, for example, several centimeters up to one meter. As the speed increases, the distance to be checked around the vehicle increases. Depending on the evaluation of the signal of the surroundings-detection apparatus 220, the method branches to a subsequent step for the execution of the first monitoring function 130 or to the execution of the second monitoring function in step 140. In step 180, the method 100 for actuating a drive assembly 210 ends. If no obstacle is detected within the predefinable distance, with step 130 the execution of the first monitoring function is carried out. The latter comprises, for example, a comparison of a setpoint value for a torque of the drive assembly 210 with an actual value of the torque of the drive assembly 210. In the event of a deviation of the two values from one another being detected, the setpoint value is correspondingly corrected. If an obstacle is detected within the predefinable distance, with step 140 the execution of the second monitoring function is carried out. The execution of the second monitoring function 140 also comprises, if appropriate, the specified method steps of the first monitoring function 130. In addition, the second monitoring function 140 comprises at least one or more further additional method steps 150, 160 . . . 170 which serve for improved or more precise monitoring of the first drive assembly 210 of the drive train 250 and/or of the vehicle 200. The risk of the vehicle moving undesirably is therefore reduced. Likewise, the probability of an undesired movement of the vehicle is further minimized.

In particular, these additional steps can serve, for example, to narrow down the monitoring boundaries. A monitoring boundary could be, for example, the speed of the vehicle, the torque of a drive assembly and/or the permissible transmission ratios of an automated transmission. Another additional step could be transfer of the vehicle into a state, in particular a special state, which protects the vehicle to the extent that an undesired movement of the vehicle could not already arise through a single system error, rather at least two errors have to occur. Such states would be, for example, the deactivation of the drive train. In this case, there would have to be both an error in the vehicle system and an error in the region of the deactivation of the drive train for an undesired movement of the vehicle to occur. So that the vehicle can be put into operation again, information relating to the deactivation of the drive train is conveyed to the driver with the transfer of the vehicle into such a state. The driver can subsequently cancel this deactivation again with an additional confirmation. Other states, e.g. opening of the transmission clutch, possibly with additional monitoring of the driver's request by the transmission, or else stopping of the creeping function, or active braking of the vehicle, are also comparable with this. These states can also be cancelled only by confirmation by the driver, for example by activation of the accelerator pedal. The second monitoring function 140 therefore comprises in its execution additional steps which minimize the probability of an undesired movement of the vehicle.

FIG. 2 shows a schematic side view of a vehicle 200 which has a surroundings-detection apparatus 220. Furthermore, a drive train 250 of the vehicle is illustrated which has a drive assembly 210 and a device 230 for actuating the drive assembly 210. The device 230 for actuating the drive assembly 210 receives a signal from the surroundings-detection apparatus 220 and evaluates it. The device 230 actuates the drive assembly 210 as a function of the evaluation of the signal of the surroundings-detection apparatus 220 by executing either a first monitoring function 130 or a second monitoring function 140 which comprises additional method steps 150 . . . 170.

1. A method for actuating a drive assembly in a vehicle, the method comprising:
observing surroundings of the vehicle with a surroundings-detection apparatus of the vehicle;
evaluating a signal of the surroundings-detection apparatus; and
executing a first monitoring function or executing a second monitoring function, as a function of the evaluation of the signal of the surroundings-detection apparatus, to avoid undesired movements of the vehicle.

2. The method as claimed in claim 2, wherein the evaluation of the signal of the surroundings-detection apparatus includes:
detecting whether an obstacle is located within a predefinable distance;
executing the first monitoring function when no obstacle is detected; and
executing the second monitoring function when an obstacle is detected.

3. The method as claimed in claim 1, wherein the first monitoring function and the second monitoring function differ.

4. The method as claimed in claim 1, wherein the execution of the second monitoring function includes:
setting a special state of the vehicle.

5. The method as claimed in claim 4, wherein the special state includes at least one of deactivation of the drive train, opening of a transmission clutch, stopping of the creeping function, and active braking of the vehicle.

6. The method as claimed in claim 1, wherein the method is carried out only within a predefinable speed range of the vehicle.

7. The method as claimed in claim 1, wherein the method is carried out only when specific traffic situations are present.

8. The method as claimed in claim 1, wherein the surroundings-detection apparatus includes:
a sensor.

9. The method as claimed in claim 1, wherein a computer program is configured to execute the method.

10. The method as claimed in claim 9, wherein the computer program is stored on a machine-readable storage medium.

11. (canceled)

12. A drive train of a vehicle, the vehicle including a surroundings-detection apparatus for observing the surroundings of the vehicle, the drive train comprising:
a drive assembly; and
a device configured to (i) evaluate a signal of the surroundings-detection apparatus and (ii) execute, as a function of the evaluation of the signal of the surroundings-detection apparatus, a first monitoring function or a second monitoring function for avoiding undesired movements of the vehicle.

13. A vehicle comprising:
a surroundings-detection apparatus configured to observe the surroundings of the vehicle; and
a drive train including:
a drive assembly; and
a device configured to (i) evaluate a signal of the surroundings-detection apparatus and (ii) execute, as a function of the evaluation of the signal of the surroundings-detection apparatus, a first monitoring function or a second monitoring function for avoiding undesired movements of the vehicle.

14. The method as claimed in claim 3, wherein the first monitoring function and the second monitoring function differ such that the execution of the second monitoring function includes at least one additional step in comparison with the execution of the first monitoring function.

15. The method as claimed in claim 8, wherein the sensor is a driver assistance system.

16. The method as claimed in claim 15, wherein the driver assistance system has a radar sensor, ultrasonic sensor, laser sensor, or a camera.
